(19) United States
(12) Patent Application Publication
(10) Pub. No.: US 2021/0382355 A1
(43) Pub. Date: Dec. 9, 2021

(54) DISPLAY PANEL AND DISPLAY DEVICE

(71) Applicant: SHENZHEN CHINA STAR OPTOELECTRONICS SEMICONDUCTOR DISPLAY TECHNOLOGY CO., LTD., Shenzhhen, Guangdong (CN)

(72) Inventor: Wei REN, Shenzhen (CN)

(73) Assignee: Shenzhen China Star Optoelectronics Semiconductor Display Technology Co., Ltd., Shenzhhen, Guangdong (CN)

(21) Appl. No.: 16/980,438

(22) PCT Filed: Jul. 14, 2020
(86) PCT No.: PCT/CN2020/101894

§ 371 Date: Sep. 14, 2020

(30) Foreign Application Priority Data
Jun. 8, 2020 (CN) 202010511617.5

(51) Int. Cl. G02F 1/1337; G02F 1/1343

(52) U.S. Cl. CPC G02F 1/133711; G02F 1/134309; G02F 1/13439

(57) ABSTRACT

A display panel and a display device are provided. The display panel comprises a first substrate and a second substrate which are disposed opposite to each other, at least two first electrodes, at least one second electrode, and liquid crystal molecules. A supporting block is disposed between the second electrode and the array substrate to increase a height of the second electrode, and when the first electrodes and the second electrode are energized, electric field lines generated by the electrodes with different polarities cover more liquid crystal molecules. Therefore, distribution of electric field is changed, deflection efficiency of the liquid crystal is increased, and transmissivity of the panel is improved.

### TECHNICAL FIELD

The present disclosure relates to the field of display technology, and in particular, to a display panel and a display device applied to in-plane switching-vertical alignment (IPS-VA).

### BACKGROUND

With development of the liquid crystal display (LCD) product market, according to the market demand for e-sports products with high frequency and high-speed animation, the demand for LCD display technology is getting higher and higher. Electronic products need to have a fast refresh frequency, then the liquid crystal demand of a quick response in the liquid crystal material display can match product demand. In current development, the response time of materials is limited, and it is necessary to develop new display modes to improve response times of LCDs.

FIG. 1 illustrates a new display mode developed at present. In the new display mode, positive and negative electrodes are horizontal. When the liquid crystal is deflected, although an effect time of the displayed liquid crystal can be improved, the liquid crystal between adjacent electrodes is not deflected, resulting in failure of the liquid crystals in these regions to achieve their functions, and simulation results show that there is a loss of transmissivity (as shown in marked areas 10 in FIG. 2 which correspond to the undeflected regions between the electrodes in FIG. 1).

Therefore, it is urgent to provide a display panel and a display device to improve an unsatisfactory deflection effect of partial areas of the panel, so as to improve the transmissivity of the partial areas of the panel.

### SUMMARY

The technical problem to be solved by the present disclosure is to provide a display panel and a display device, which can improve an unsatisfactory deflection effect of partial areas of the panel, so as to improve the transmissivity of the partial areas of the panel.

To solve the above problem, an embodiment of the present disclosure provides a display panel comprising a first substrate and a second substrate which are disposed opposite to each other, at least two first electrodes disposed on the first substrate, at least one second electrode disposed on the first substrate and between the at least two first electrodes, wherein polarities of the first electrodes and the second electrode are different, and liquid crystal molecules disposed between the first substrate and the second substrate in an array arrangement, wherein a supporting block is disposed between the second electrode and the first substrate.

In an embodiment, a height of the supporting block is greater than those of the first electrodes.

In an embodiment, a material of the supporting block comprises a color resist.

In an embodiment, the liquid crystal molecules are polymer-sustained vertical alignment-type (PSVA).

In an embodiment, the first electrodes are positive electrodes or negative electrodes, and the second electrode is a negative electrode or a positive electrode.

In an embodiment, the display panel further comprises a first alignment layer disposed on the first substrate, the first electrodes, and the second electrode, and a second alignment layer disposed at a side of the second substrate facing the liquid crystal molecules.

In an embodiment, materials of the first electrodes comprise indium tin oxide, and/or, a material of the second electrode comprises indium tin oxide.

In an embodiment, widths of the first electrodes range from 2 μm to 3 μm, and/or, a width of the second electrode ranges from 2 μm to 3 μm, and/or, distances between the first electrodes and the second electrode range from 7 μm to 12 μm.

In an embodiment, a height of the supporting block ranges from 0.5 μm to 1.5 μm.

An embodiment of the present disclosure provides a display device comprising the display panel described above.

In the display panel and the display device provided in the embodiments of the present disclosure, the supporting block is disposed between the second electrode and the array substrate to increase a height of the second electrode, and when the first electrodes and the second electrode are energized, electric field lines generated by the electrodes with different polarities cover more liquid crystal molecules. Therefore, a distribution of electric field is changed, a deflection efficiency of the liquid crystal is increased, and the transmissivity of the panel is improved.

### BRIEF DESCRIPTION OF DRAWINGS

FIG. 1 is a schematic structural diagram illustrating a deflection of liquid crystals of a display panel in the prior art.

FIG. 2 is a measurement simulation graph illustrating transmissivity of the display panel in the prior art according to different positions in FIG. 1.

FIG. 3 is a schematic structural diagram illustrating a deflection of liquid crystals of a display panel provided in an embodiment of the present disclosure.

FIG. 4 is a measurement simulation graph illustrating transmissivity of display panels using supporting blocks with different heights provided in an embodiment of the present disclosure.

FIG. 5 is a schematic structural diagram illustrating a display panel provided in an embodiment of the present disclosure.

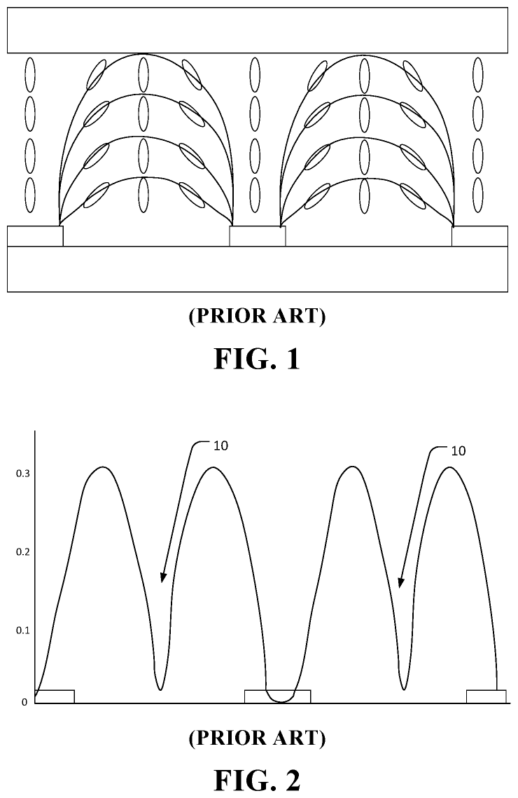

Display panel 100; display device 200; first substrate 101; second substrate 102; first electrode 104; second electrode 105; liquid crystal molecule 103; supporting block 106; lower polarizer 201; upper polarizer 202; passivation layer 107; first alignment layer 109; second alignment layer 108.

### DETAILED DESCRIPTION OF PREFERRED EMBODIMENTS

Embodiments of the present disclosure provide a physical keyboard input system, a keyboard input method and a storage medium. To make the objectives, technical solutions, and effects of the present disclosure clearer and more specific, the present disclosure is described in further detail below with reference to the embodiments accompanying with drawings. It should be understood that the specific embodiments described herein are merely for explaining the present disclosure, and not used to limit the present disclosure.

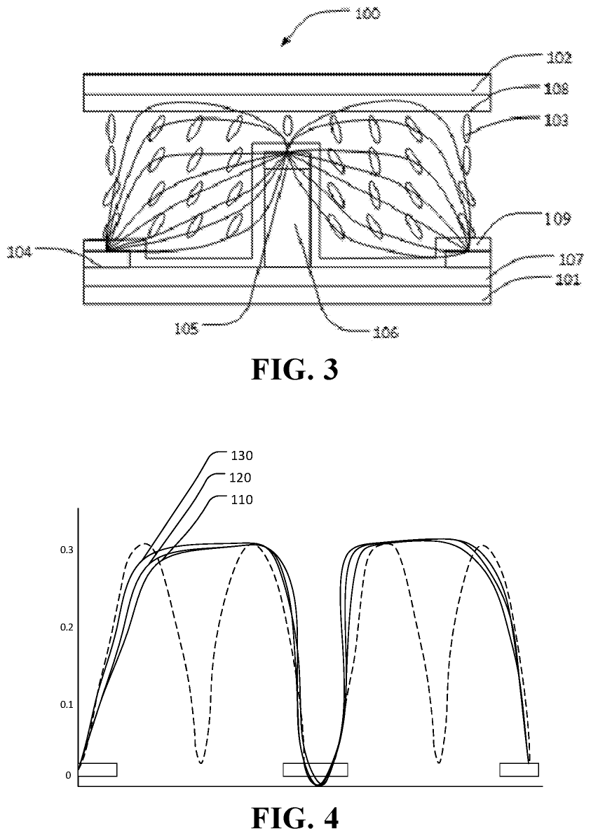

As shown in FIG. 3, an embodiment of the present disclosure provides a display panel 100 comprising a first substrate 101 and a second substrate 102 which are disposed opposite to each other, at least two first electrodes 104, at least one second electrode 105, and liquid crystal molecules 103.

The first substrate 101 is an array substrate and the second substrate 102 is a color filter substrate.

The first electrodes 104 are disposed on the first substrate 101.

The second electrode 105 is disposed on the first substrate 101 and between two of the first electrodes 104. A polarity of the second electrode 105 is different from those of the first electrodes 104. Thus, an electric field can be generated to deflect the liquid crystal molecule 103.

The display panel 100 further comprises a passivation layer 107, a first alignment layer 109, and a second alignment layer 108.

The passivation layer 107 is disposed on the first substrate 101.

The first alignment layer 109 is disposed on the first substrate 101, the first electrodes 104, and the second electrode 105.

The second alignment layer 108 is disposed at a side of the second substrate 102 facing the liquid crystal molecules 103.

The first electrodes 104 are positive electrodes or negative electrodes, and the second electrode 105 is a negative electrode or a positive electrode.

Materials of the first electrodes 104 comprise indium tin oxide, and/or a material of the second electrode 105 comprises indium tin oxide.

Widths of the first electrodes 104 range from 2 μm to 3 μm, and/or a width of the second electrode 105 ranges from 2 μm to 3 μm, and/or distances between the first electrodes 104 and the second electrode 105 range from 7 μm to 12 μm.

The first electrodes 104 and the second electrode 105 are pixel electrodes.

The liquid crystal molecules 103 are disposed between the first substrate 101 and the second substrate 102 in an array arrangement. The liquid crystal molecules 103 are polymer-stabilized vertically alignment-type (PSVA) liquid crystals.

The liquid crystal molecules 103 are elliptic and long axes thereof are perpendicular to the first substrate 101 and the second substrate 102.

A supporting block 106 is disposed between the second electrode 105 and the array substrate.

A height of the supporting block 106 is greater than those of the first electrodes 104, a material of the supporting block 106 comprises a color resist, and a height of the supporting block 106 ranges from 0.5 μm to 1.5 μm.

In the embodiments of the present disclosure, the supporting block 106 is disposed between the second electrode 105 and the array substrate to increase a height of the second electrode 105, and when the first electrodes 104 and the second electrode 105 are energized, electric field lines generated by the electrodes with different polarities cover more liquid crystal molecules 103. Therefore, a distribution of electric field (which is a distribution of electric field in FIG. 3) is changed, a deflection efficiency of the liquid crystals is increased, and the transmissivity of the panel is improved.

In comparison with the display panel in the prior art, the transmissivity of the display panel in the embodiments of the present disclosure can be increased from 14.5% to 17.6%, and a driving voltage (7V) is increased from 21.0% to 23.1% (a driving voltage of 10V).

FIG. 4 illustrates measurement simulation graphs 110, 120, and 130 of the transmissivity of display panels using supporting blocks with different heights provided in an embodiment of the present disclosure, compared with a measurement simulation graph (which is shown by dashed lines) of transmissivity of the display panel in the prior art. The display panel provided in an embodiment of the present disclosure has a normal transmissivity in the marked areas 10 shown in FIG. 2, and it can be seen that the deflections are generated in FIG. 3 corresponding to the marked areas 10 in FIG. 2.

The height of the supporting block 106 corresponding to the graph 110 is 0.6 μm and the height of the supporting block 106 corresponding to the graph 120 is 1 μm; the height of the supporting block 106 corresponding to the graph 130 is 0.6 μm and the height of the supporting block 106 corresponding to the graph 120 is 1.5 μm.

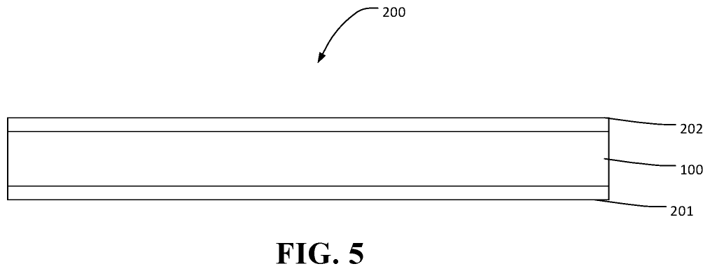

As shown in FIG. 5, an embodiment of the present disclosure provides a display device 200 comprising a display panel 100, an upper polarizer 202, and a lower polarizer 201. The display panel 100 is disposed between the upper polarizer 202 and the lower polarizer 201.

The display panel 100 comprises a first substrate 101 and a second substrate 102 which are disposed opposite to each other, at least two first electrodes 104, at least one second electrode 105, and liquid crystal molecules 103.

The first substrate 101 is an array substrate, and the second substrate 102 is a color filter substrate.

The first electrodes 104 are disposed on the array substrate.

The second electrode 105 is disposed on the array substrate and between two of the first electrodes 104. A polarity of the second electrode 105 is different from those of the first electrodes 104. Thus, an electric field can be generated to deflect the liquid crystal molecule 103.

The first electrodes 104 are positive electrodes or negative electrodes, and the second electrode 105 is a negative electrode or a positive electrode.

Materials of the first electrodes 104 comprise indium tin oxide, and/or, a material of the second electrode 105 comprises indium tin oxide.

Widths of the first electrodes 104 range from 2 μm to 3 μm, and/or, a width of the second electrode 105 ranges from 2 μm to 3 μm, and/or, distances between the first electrodes 104 and the second electrode 105 range from 7 μm to 12 μm.

The liquid crystal molecules 103 are disposed between the first substrate 101 and the second substrate 102 in an array arrangement. The liquid crystal molecules 103 are PSVA.

The liquid crystal molecules 103 are elliptic and long axes thereof are perpendicular to the first substrate 101 and the second substrate 102.

A supporting block 106 is disposed between the second electrode 105 and the array substrate.

A height of the supporting block 106 is greater than those of the first electrodes 104, a material of the supporting block 106 comprises a color resist, and a height of the supporting block 106 ranges from 0.5 μm to 1.5 μm.

In the embodiments of the present disclosure, the supporting block 106 is disposed between the second electrode 105 and the array substrate to increase a height of the second electrode 105, and when the first electrodes 104 and the second electrode 105 are energized, electric field lines generated by the electrodes with different polarities cover more liquid crystal molecules 103. Therefore, a distribution of electric field (which is a distribution of electric field in FIG. 3) is changed, a deflection efficiency of the liquid crystals is increased, and the transmissivity of the panel is improved.

It can be understood that, for those skilled in the art, equivalent replacements and modifications can be made according to the technical solution and disclosure ideas thereof of the present disclosure, and all these modifications or replacements are considered within the protection scope of the attached claims of the present disclosure.

1. A display panel, comprising:
a first substrate and a second substrate disposed opposite to each other;
at least two first electrodes disposed on the first substrate;
at least one second electrode disposed on the first substrate and between the at least two first electrodes, wherein polarities of the first electrodes and the second electrode are different; and
liquid crystal molecules disposed between the first substrate and the second substrate in an array arrangement;
wherein a supporting block is disposed between the second electrode and the first substrate.

2. The display panel as claimed in claim 1, wherein a height of the supporting block is greater than heights of the first electrodes.

3. The display panel as claimed in claim 1, wherein a material of the supporting block comprises a color resist.

4. The display panel as claimed in claim 3, wherein the liquid crystal molecules are polymer-sustained vertical alignment-type (PSVA).

5. The display panel as claimed in claim 1, wherein the first electrodes are positive electrodes or negative electrodes, and the second electrode is a negative electrode or a positive electrode.

6. The display panel as claimed in claim 1, further comprising:
a first alignment layer disposed on the first substrate, the first electrodes, and the second electrode; and
a second alignment layer disposed at a side of the second substrate facing the liquid crystal molecules.

7. The display panel as claimed in claim 1, wherein materials of the first electrodes comprise indium tin oxide, and/or a material of the second electrode comprises indium tin oxide.

8. The display panel as claimed in claim 1, wherein widths of the first electrodes range from 2 μm to 3 μm, and/or a width of the second electrode ranges from 2 μm to 3 μm, and/or distances between the first electrodes and the second electrode range from 7 μm to 12 μm.

9. The display panel as claimed in claim 1, wherein a height of the supporting block ranges from 0.5 μm to 1.5 μm.

10. A display device, comprising a display panel, the display panel comprising:
a first substrate and a second substrate which are disposed opposite to each other;
at least two first electrodes disposed on the first substrate;
at least one second electrode disposed on the first substrate and between the at least two first electrodes, wherein polarities of the first electrodes and the second electrode are different; and
liquid crystal molecules disposed between the first substrate and the second substrate in an array arrangement;
wherein a supporting block is disposed between the second electrode and the first substrate.

11. The display device as claimed in claim 10, wherein a height of the supporting block is greater than heights of the first electrodes.

12. The display device as claimed in claim 10, wherein a material of the supporting block comprises a color resist.

13. The display device as claimed in claim 12, wherein the liquid crystal molecules are polymer-sustained vertical alignment-type (PSVA).

14. The display device as claimed in claim 10, wherein the first electrodes are positive electrodes or negative electrodes, and the second electrode is a negative electrode or a positive electrode.

15. The display device as claimed in claim 10, wherein the display panel further comprises:
a first alignment layer disposed on the first substrate, the first electrodes, and the second electrode; and
a second alignment layer disposed at a side of the second substrate facing the liquid crystal molecules.

16. The display device as claimed in claim 10, wherein materials of the first electrodes comprise indium tin oxide, and/or a material of the second electrode comprises indium tin oxide.

17. The display device as claimed in claim 10, wherein widths of the first electrodes range from 2 μm to 3 μm, and/or a width of the second electrode ranges from 2 μm to 3 μm, and/or distances between the first electrodes and the second electrode range from 7 μm to 12 μm.

18. The display device as claimed in claim 10, wherein a height of the supporting block ranges from 0.5 μm to 1.5 μm.
